(19) United States
(12) Patent Application Publication
(10) Pub. No.: US 2014/0266909 A1
(43) Pub. Date: Sep. 18, 2014

(54) METHODS FOR LCI DISAMBIGUATION

(71) Applicant: QUALCOMM INCORPORATED, San Diego, CA (US)

(72) Inventors: Ravi PALANKI, Cupertino, CA (US); Faraz Mohammad MIRZAEI, San Jose, CA (US); Saumitra Mohan DAS, Santa Clara, CA (US)

(73) Assignee: QUALCOMM INCORPORATED, San Diego, CA (US)

(21) Appl. No.: 13/796,657

(22) Filed: Mar. 12, 2013

(51) Int. Cl. G01S 5/02

(52) U.S. Cl. CPC G01S 5/02
USPC 342/451

(57) ABSTRACT

Various arrangements for performing location disambiguation are presented. A mobile device may receive a plurality of location hypotheses. The mobile device may also receive an indication of a disambiguation evaluation technique selected from a plurality of disambiguation evaluation techniques. The mobile device may perform the disambiguation evaluation technique using the plurality of location hypotheses. Using the disambiguation evaluation technique, a location hypothesis of the plurality of location hypotheses may be selected by the mobile device as corresponding to the mobile device's location.

### BACKGROUND

Using a mobile device, such as a cellular phone, for navigation has become commonplace. The mobile device may present a user with a map that displays the mobile device's location on the map. Commonly, users interact with outdoor-focused maps, such as a street map. Maps may also be useful for indoor locations. However, in situations where maps for indoor locations are used, various challenges to successfully locate a position of the mobile device on the indoor map may exist.

### SUMMARY

In some embodiments, a method for performing location disambiguation is presented. The method may include receiving, by a mobile device, a plurality of location hypotheses. The method may include receiving, by the mobile device, an indication of a disambiguation evaluation technique selected from a plurality of disambiguation evaluation techniques. The disambiguation evaluation technique may be used for performing location disambiguation. The method may include performing, by the mobile device, the disambiguation evaluation technique using the plurality of location hypotheses. The method may include selecting, by the mobile device, a location hypothesis of the plurality of location hypotheses as corresponding to a location of the mobile device based on the performed disambiguation evaluation technique.

In embodiments of such a method, one or more of the following may be present: Prior to receiving, by the mobile device, the plurality of location hypotheses, the method may include: determining, by the mobile device, a location estimate of the mobile device; and transmitting, by the mobile device, the location estimate to a remote server system, wherein the plurality of location hypotheses are selected by the remote server system based on the location estimate. The method may include receiving, by the remote server system, the location estimate from the mobile device. The method may include selecting, by the remote server system, the disambiguation evaluation technique selected from the plurality of disambiguation evaluation techniques based on the location estimate received from the mobile device. The method may include transmitting, by the remote server system, the indication of the disambiguation evaluation technique selected from the plurality of disambiguation evaluation techniques to the mobile device. The method may include receiving, by the remote server system, the location estimate from the mobile device. The method may include determining, by the remote server system, the plurality of location hypotheses based on the location estimate. The method may include transmitting, by the remote server system, the plurality of location hypotheses based on the location estimate to the mobile device. The method may include transmitting, by the mobile device, an indication of the location hypothesis selected as corresponding to the location of the mobile device to a remote server system.

Additionally or alternatively, in embodiments of such a method, one or more of the following may be present: The method may include, in response to transmitting the indication of the location hypothesis selected as corresponding to the location of the mobile device, receiving, by the mobile device, a map linked with the location hypothesis selected by the mobile device as corresponding to the location of the mobile device. The method may include receiving, by the mobile device, user input indicating the map does not correspond to the location of the mobile device. The method may include transmitting, by the mobile device, an error notification. The error notification may indicate the map has been identified as incorrect by user input. The error notification may be used by the remote server system to modify one or more future selections of the disambiguation evaluation technique from the plurality of disambiguation evaluation techniques. The method may include receiving, by the mobile device, a tuning parameter for the disambiguation evaluation technique for use in performing the disambiguation evaluation technique. The method may include performing the disambiguation evaluation technique further comprises using the tuning parameter. Each location hypothesis of the plurality of location hypotheses may correspond to a different floor of a building. Each location hypothesis of the plurality of location hypotheses may correspond to a different region of a building.

In some embodiments, a mobile device for performing location disambiguation is presented. The mobile device may include one or more processors. The mobile device may include a memory communicatively coupled with and readable by the one or more processors and having stored therein processor-readable instructions. When executed by the one or more processors, the processor-readable instructions may cause the one or more processors to receive a plurality of location hypotheses. The instructions may cause the one or more processors to receive an indication of a disambiguation evaluation technique selected from a plurality of disambiguation evaluation techniques. The disambiguation evaluation technique may be used for performing location disambiguation. The instructions may cause the one or more processors to perform the disambiguation evaluation technique using the plurality of location hypotheses. The instructions may cause the one or more processors to select a location hypothesis of the plurality of location hypotheses as corresponding to a location of the mobile device based on the performed disambiguation evaluation technique.

Embodiments of such a device may include one or more of the following: The instructions may cause the one or more processors to, prior to receiving the plurality of location hypotheses: determine a location estimate of the mobile device; and cause the location estimate to be transmitted to a remote server system, wherein the plurality of location hypotheses are selected by the remote server system based on the location estimate. The instructions may cause the one or more processors to cause an indication of the location hypothesis selected as corresponding to the location of the mobile device to be transmitted to a remote server system. The instructions may cause the one or more processors to receive a map linked with the location hypothesis selected by the mobile device as corresponding to the location of the mobile device. The instructions may cause the one or more processors to receive user input indicating the map does not correspond to the location of the mobile device. The instructions may cause the one or more processors to cause an error notification to be transmitted to the remote server system. The error notification may indicate the map has been identified as incorrect by user input. The error notification may be used by the remote server system to modify one or more future selections of the disambiguation evaluation technique from the plurality of disambiguation evaluation techniques. The instructions may cause the one or more processors to receive a tuning parameter for the disambiguation evaluation technique for use in performing the disambiguation evaluation technique. The processor-readable instructions that cause the one or more processors to perform the disambiguation evaluation technique may include additional processor-readable instructions that cause the one or more processors to perform the disambiguation evaluation technique using the tuning parameter. Each location hypothesis of the plurality of location hypotheses may correspond to a different floor of a building. Each location hypothesis of the plurality of location hypotheses may correspond to a different region of a building.

In some embodiments, a non-transitory processor-readable medium for performing location disambiguation is present. The non-transitory processor-readable medium may include instructions configured to cause one or more processors to receive a plurality of location hypotheses. The instructions may be further configured to cause the one or more processors to receive an indication of a disambiguation evaluation technique selected from a plurality of disambiguation evaluation techniques. The disambiguation evaluation technique may be used for performing location disambiguation. The instructions may be further configured to cause the one or more processors to perform the disambiguation evaluation technique using the plurality of location hypotheses. The instructions may be further configured to cause the one or more processors to select a location hypothesis of the plurality of location hypotheses as corresponding to a location of a mobile device based on the performed disambiguation evaluation technique.

Embodiments of such a non-transitory processor-readable medium may include one or more of the following: The instructions may be further configured to cause the one or more processors to, prior to receiving the plurality of location hypotheses: determine a location estimate of the mobile device; and cause the location estimate to be transmitted to a remote server system, wherein the plurality of location hypotheses are selected by the remote server system based on the location estimate. The instructions may be further configured to cause the one or more processors to cause an indication of the location hypothesis selected as corresponding to the location of the mobile device to be transmitted to a remote server system. The instructions may be further configured to cause the one or more processors to receive a map linked with the location hypothesis selected by the mobile device as corresponding to the location of the mobile device. The instructions may be further configured to cause the one or more processors to receive user input indicating the map does not correspond to the location of the mobile device.

Additionally or alternatively, embodiments of such a non-transitory processor-readable medium may include one or more of the following: The instructions may be further configured to cause the one or more processors to cause an error notification to be transmitted to the remote server system. The error notification may indicate the map has been identified as incorrect by user input. The error notification may be used by the remote server system to modify one or more future selections of the disambiguation evaluation technique from the plurality of disambiguation evaluation techniques. The instructions may be further configured to cause the one or more processors to receive a tuning parameter for the disambiguation evaluation technique for use in performing the disambiguation evaluation technique. The processor-readable instructions that cause the one or more processors to perform the disambiguation evaluation technique further comprises additional processor-readable instructions that cause the one or more processors to perform the disambiguation evaluation technique using the tuning parameter. Each location hypothesis of the plurality of location hypotheses may correspond to a different floor of a building. Each location hypothesis of the plurality of location hypotheses may correspond to a different region of a building.

In some embodiments, an apparatus for performing location disambiguation. The apparatus may include means for receiving a plurality of location hypotheses. The apparatus may include means for receiving an indication of a disambiguation evaluation technique selected from a plurality of disambiguation evaluation techniques. The disambiguation evaluation technique may be used for performing location disambiguation. The apparatus may include means for performing the disambiguation evaluation technique using the plurality of location hypotheses. The apparatus may include means for selecting a location hypothesis of the plurality of location hypotheses as corresponding to a location of a mobile device based on the performed disambiguation evaluation technique.

Embodiments of such an apparatus may include one or more of the following: The apparatus may include means for determining a location estimate of the mobile device. The apparatus may include means for transmitting the location estimate to a remote server system, wherein the plurality of location hypotheses are selected by the remote server system based on the location estimate. The apparatus may include means for receiving the location estimate from the mobile device. The apparatus may include means for selecting the disambiguation evaluation technique selected from the plurality of disambiguation evaluation techniques based on the location estimate received from the mobile device. The apparatus may include means for transmitting the indication of the disambiguation evaluation technique selected from the plurality of disambiguation evaluation techniques to the mobile device. The apparatus may include means for receiving the location estimate from the mobile device. The apparatus may include means for determining the plurality of location hypotheses based on the location estimate.

Additionally or alternatively, embodiments of such an apparatus may include one or more of the following: The apparatus may include means for transmitting the plurality of location hypotheses based on the location estimate to the mobile device. The apparatus may include means for transmitting an indication of the location hypothesis selected as corresponding to the location of the mobile device to a remote server system. The apparatus may include means for receiving a map linked with the location hypothesis selected by the mobile device as corresponding to the location of the mobile device. The apparatus may include means for receiving user input indicating the map does not correspond to the location of the mobile device. The apparatus may include means for transmitting an error notification. The error notification may indicate the map has been identified as incorrect by user input. The error notification may be used by the remote server system to modify one or more future selections of the disambiguation evaluation technique from the plurality of disambiguation evaluation techniques. The apparatus may include means for receiving a tuning parameter for the disambiguation evaluation technique for use in performing the disambiguation evaluation technique. The means for performing the disambiguation evaluation technique further may include using the tuning parameter. Each location hypothesis of the plurality of location hypotheses may correspond to a different floor of a building. Each location hypothesis of the plurality of location hypotheses may correspond to a different region of a building.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system for performing LCI disambiguation.

FIG. 2 illustrates an embodiment of a mobile device configured to perform LCI disambiguation.

FIG. 3 illustrates an embodiment of an indoor map presented by a mobile device.

FIG. 4 illustrates an embodiment of a method for performing LCI disambiguation.

FIG. 5 illustrates another embodiment of a method for performing LCI disambiguation.

FIG. 6 illustrates an embodiment of a method for using user feedback in performing LCI disambiguation.

FIG. 7 illustrates an embodiment of a computer system.

### DETAILED DESCRIPTION

Many uses of indoor maps exist. As an example, a user may find an indoor map of a store, a mall, or office building to be useful. The user may find such indoor maps especially useful if the user's location (which may be approximately the same as a mobile device's location if the mobile device is possessed by the user) is indicated on the map. A user may, for instance, want to determine where the user is located within a mall in relation to a store that the user desires to visit. As another simple example, a user in an office setting may desire to locate a conference room having wireless network access. Further, other forms of indoor maps, such as maps directed to wireless signal strength or connectivity, may be useful. Other reasons, such as for tagging the location of a photograph, may exist for why determining the mobile device's position indoors accurately. As another example, a heat map of received signal strength indication (RSSI) measurements in the area where the mobile device is located may be downloaded to allow performance of high-resolution or high-accuracy localization.

For an indoor map to be useful, it may be necessary for the mobile device to be aware of its own location. For example, if a user is within a multistory building, the user's mobile device may need to determine which floor it is located on; if the mobile device determines it is located on an incorrect floor, a map presented to the user by the mobile device for the incorrect floor of the building may not be useful. In order to provide a mobile device with a correct map for display, it may be necessary to determine on which floor of a building the mobile device is located and/or in what region of the interior of a building the mobile device is located. In determining the floor of the building on which the mobile device is located and/or the region of the interior of the building in which the mobile device is located, the mobile device may not have access to the same location-determining systems as would possibly be available in an outdoor environment or such location-determining systems may not be sufficiently accurate. For example, the mobile device (possibly due to interference caused by the building and its contents) may not receive signals from a satellite-based navigation system, such as the Global Positioning System (GPS), or the satellite-based navigation system may not yield a location of the mobile device with sufficient accuracy to determine the correct floor of the building or the region of the interior of the building where the mobile device is located. Further, it may not be possible to perform trilateration or triangulation using cellular network signals from multiple base stations (again, possibly due to interference caused by the building and its contents), or base station trilateration/triangulation may not provide a location of the mobile device with sufficient accuracy to determine the correct floor of the building or the region of the interior of the building where the mobile device is located.

In order for a mobile device's position on an indoor map to be correctly identified, the mobile device may need to request the appropriate assistance data (e.g., the map of the floor of the building where the mobile device is located). A location context identifier (LCI) may correspond to a particular floor within a building and/or a particular segment of a floor within the building. The term “LCI disambiguation” refers to determining the proper LCI associated with a mobile device's location. A location context identifier may be an identifier that is used to request a particular map. For instance, each map (or segment of a map) may be associated with a particular LCI.

For reasons such as to decrease the amount of processing required to be performed at a remote server system and/or to decrease the amount of data required to be transmitted to the remote server, it may be useful to perform steps of LCI disambiguation at the mobile device.

FIG. 1 illustrates an embodiment of a system 100 for performing LCI disambiguation. System 100 may include a mobile device 110, local area network 120, the Internet 130, a cellular wireless network (represented by base station 140), a remote server system 150, databases 155, and access points 180. It should be understood that in alternate embodiments of system 100, additional or fewer components may be present.

Mobile device 110 represents a computerized device that is capable of communicating with one or more types of wireless networks. Mobile device 110 may be capable of communicating with one or more wireless cellular networks. Mobile device 110 may also be capable of receiving and/or communicating with local wireless networks and/or beacons. Mobile device 110 may be a cellular phone (such as a smart phone). Mobile device 110 may also be a tablet computer, personal digital assistant, music player, gaming device, laptop computer, or various other forms of computerized devices.

Mobile device 110 may be able to communicate wirelessly with base station 140 of a cellular wireless network, represented visually in FIG. 1 by a base station. Mobile device 110 may be able to communicate with base station 140 regardless of whether mobile device 110 is indoors or outdoors. In some situations, interference at least partially caused by being indoors may negatively impact the ability of mobile device 110 to communicate with base station 140. While a single base station is illustrated in FIG. 1, it should be understood that a cellular wireless network may have many base stations capable of communicating with mobile device 110 depending on where mobile device 110 is located. If mobile device 110 is in communication with a sufficient number of base stations, a position-determining technique of trilateration and/or triangulation may be performed to obtain a position of mobile device 110. Such a position-determining technique may not be accurate and precise enough to locate mobile device 110 on a specific floor of a building and/or within a specific region of a floor of a building. As such, a position-determining technique of trilateration and/or triangulation may be used as a position estimate for mobile device 110 but may not be sufficient to determine a correct map to be provided to mobile device 110.

Mobile device 110 may communicate with remote server system 150 via base station 140 of the cellular wireless network. For example, data may be transmitted to and from mobile device 110 to remote server system 150 via base station 140 and Internet 130. Mobile device 110 may also communicate wirelessly with access points 180. Access points 180 may be configured to permit mobile device 110 to communicate with remote server system 150 via local area network 120 and/or Internet 130. As such, in some embodiments, mobile device 110 may use access points 180 and/or base station 140 of a cellular wireless network to communication with remote server system 150. For simplicity, while mobile device 110 may at least receive wireless signals from each of access points 180, a single wireless communication signal is illustrated between mobile device 110 and access point 180-3 for simplicity of FIG. 1.

In some embodiments, mobile device 110 can perform two-way communication with remote server system 150 via one or more of access points 180. In other embodiments, mobile device 110 may be able to receive signals from one or more access points of access points 180 but may not use one or more access points of access points 180 to communicate with remote server system 150. For access points through which mobile device 110 is not permitted to communicate with remote server system 150, mobile device 110 may be able to receive at least an identifier of the access point. Mobile device 110 may be able to perform a signal strength measurement (additionally or alternatively, round trip times (RTT) may be measured) on this received wireless signal. As an example of an access point through which mobile device 110 may not be permitted to communicate with remote server system 150, an access point may be a wireless router of a local wireless network (such as an 802.11b/g wireless network) to which mobile device 110 does not have access credentials (e.g., the network passcode). As such, mobile device 110 may receive a signal identifying the access point (such as a service set identifier (SSID)), but may not communicate with other computerized devices through the access point.

Access points 180 may be used for providing wireless network access in a location, such as within building 160. Floor 170 represents the second floor of building 160. On floor 170, four access points 180 are present. Access points 180 may be wireless routers which communicate with and/or function as local area network 120. In some embodiments, some or all of access points 180 may be beacons. Such beacons may not provide network access; rather, such beacons may only periodically transmit an identification of the beacon and may not receive data. Beacons may not be in communication with local area network 120 or Internet 130. While present in and/or around building 160, mobile device 110 may be in communication with one or more of access points 180. Such communication may involve being able to communicate with remote server system 150 or just receive signals (e.g., beaconing data) from one or more access points 180. Which access points 180 that mobile device 110 is in communication with may vary based on the location of mobile device 110 and access points 180 within building 160. While only access points present on floor 170 are illustrated in FIG. 1, it should be understood that mobile device 110 may also receive signals from access points located on other floors of building 160, in different regions of the same floor of building 160, and/or outside building 160. For example, mobile device 110 may also receive wireless signals from one or more access points located on the first and third floors of building 160.

Whether via access points 180 or via base station 140, mobile device 110 may communicate with remote server system 150. Mobile device 110 may communicate with remote server system 150 in order to determine a map to be presented by mobile device 110 to a user of mobile device 110. Based on an estimate of the location of mobile device 110, remote server system 150 may hypothesize about where (e.g., what floor of a building or what region of a floor of a building) mobile device 110 is located. Remote server system 150 may have access to multiple databases. While four databases are illustrated in system 100 of FIG. 1, it should be understood that the data contained in such databases may be combined into fewer databases or divided out into a greater number of databases. Further, it may be possible that storage arrangements other than databases may be used by remote server system 150 to store data to be used to provide mobile device 110 with a map corresponding to where mobile device 110 is located.

Technique database 155-1 may indicate multiple techniques that can be used to determine the location of mobile device 110 based on access point signal measurements conducted by mobile device 110. Different techniques may be used for determining the location of mobile device 110 for multiple reasons. For example, based on empirical data, it may be determined that in a particular building, on a floor, or a region of the floor, a first disambiguation evaluation technique may work better than a second disambiguation evaluation technique. In another building, floor, or region of the same floor, the second disambiguation evaluation technique may be more effective than the first disambiguation evaluation technique. Remote server system 150 may have access to a database of the various disambiguation evaluation techniques which should be used based on the location estimate of mobile device 110.

Access point database 155-2 may indicate identifiers (such as MAC addressed, SSIDs, etc.) of access points (which may include wireless routers, beacons, etc.) and corresponding locations. Therefore, access point database 155-2 may store identifiers of each access point of access points 180 along with location information on each access point of access points 180. The location information for each access point may be specific such as a specific location on a floor of a building; in some embodiments, the location information may be more general, such as on which floor an access point is located within a building.

Map database 155-3 may be a database storing maps for multiple locations. For example, map database 155-3 may have maps for different floors within the building and/or different regions of a floor building. Further, map database 155-3 may have maps for different buildings. Map database 155-3 may also have different types of maps; for example, some maps of map database 155-3 may indicate the physical layout of a floor of a building, while other maps of map database 155-3 may indicate a heat map of wireless network RSSI measurements. Each map present within map database 155-3 may be associated with an identifier unique from each other map within map database 155-3. This identifier may be referred to as a location context identifier (LCI). By determining a correct LCI for a location of mobile device 110, a correct map from map database 155-3 may be provided to mobile device 110.

In some instances, the map provided to mobile device 110 by remote server system 150 may be incorrect. For example, while mobile device 110 is located on floor 170 (which is the second floor) of building 160, mobile device 110 may be incorrectly provided with a map for the first floor of building 160. The user of mobile device 110 may provide input to mobile device 110 that indicates the map provided is incorrect. Such feedback may be transmitted by mobile device 110 to a remote server system 150. Such feedback may be stored in feedback database 155-4. This feedback data may be used to improve future performance. For example, if an incorrect map is provided to mobile device 110 and a first disambiguation technique from technique database 155-1 was used, negative feedback received from mobile device 110 that is stored in feedback database 155-4 may result in a different disambiguation technique being used for mobile device 110 (and/or other mobile devices) for future requests for a map in the general area where mobile device 110 received the incorrect map. Further, just as negative feedback may be stored by feedback database 155-4 to improve the chances of a correct map being provided to mobile device 110, positive feedback, such as vindication provided by a user to mobile device 110 that the map is correct, may also be stored by feedback database 155-4 to further improve the chances of the correct map being provided to mobile device 110 (and/or other mobile devices) in the future.

While FIG. 1 illustrates a single mobile device on a single floor of building 160 in communication with remote server system 150, it should be understood that many mobile devices may be in communication with remote server system 150 and may rely on remote server system 150 to provide maps to mobile devices. Feedback provided by one mobile device may affect which disambiguation technique is used (and possibly which map is provided) for other mobile devices.

FIG. 2 illustrates an embodiment of a mobile device 200 configured to perform LCI disambiguation. Mobile device 200 may include processing module 210 (which may include location estimation engine 212 and disambiguation evaluation engine 214), cellular network transceiver 220, satellite-based position receiver 230, a local wireless network transceiver 240, display 250, and user input module 260. It should be understood that such components of mobile device 200 are presented in block format only, and computerized hardware may be used to perform functions of the various components of mobile device 200. For example, processors and non-transitory computer readable storage mediums may be used as part of mobile device 200. Computer system 700 of FIG. 7 presents various components which may be incorporated as part of mobile device 200. Functions of various components of mobile device 200 may be performed using software, firmware, and/or hardware. Functionality of various components of mobile device 200 may be performed by the same component of mobile device 200; for example, a single processor may perform the functions of processing module 210. Mobile device 200 may represent an embodiment of a mobile device 110 of FIG. 1.

Processing module 210 may perform multiple functions. Location estimation engine 212 may use data collected from cellular network transceiver 220 and/or satellite-based position receiver 230 in order to estimate location of the mobile device. Estimating the location of the mobile device may be performed by location estimation engine 212 in multiple ways. For example, location estimation engine 212 may base the location of the mobile device on the last determined position from data of cellular network transceiver 220, and/or satellite-based position receiver 230.

Referring to cellular network transceiver 220, if mobile device 200 is in communication with at least three base stations of one or more cellular wireless networks, triangulation or trilateration techniques may be used to determine the position of the mobile device. If mobile device 200 is located outside, it may be more likely that cellular network transceiver 220 can communicate with three or more base stations of cellular wireless networks. However, if mobile device 200 is brought indoors, mobile device 200 may not receive signals from a sufficient number of base stations via cellular network transceiver 220 to perform additional trilateration or triangulation measurements. As such, to perform location estimation, location estimation engine 212 may base the location estimate on the most recent trilateration or triangulation measurements, which may have occurred before the mobile device was brought indoors. In other embodiments, it may be possible to perform a trilateration or triangulation measurement based on signals received by cellular network transceiver 220 at the time a map is being requested by mobile device 200 (even if indoors); however, the location determines using trilateration or triangulation may not be precise or accurate enough to determine which floor of a building or region of the floor of a building mobile device 200 is located on. As such, the position determined using cellular network transceiver 220 may be used for a position estimate.

Referring to satellite-based position receiver 230, if mobile device 200 can receive timing signals from at least three satellites of a satellite-based positioning system (such as GPS), the position of mobile device 200 may be calculated. If mobile device 200 is located outside, it may be more likely that satellite-based position receiver 230 can receive signals from three or more base stations of the satellite-based positioning system. However, if mobile device 200 is brought indoors, interference may prevent mobile device 200 from receiving signals from a sufficient number of satellites via satellite-based position receiver 230 to determine the location of mobile device 200. As such, to perform location estimation, location estimation engine 212 may base the location estimate on the most recent location determination performed based on timing signals received via satellite-based position receiver 230, which may have occurred before the mobile device was brought indoors. In other embodiments, it may be possible to determine the position of the mobile device based on signals received by satellite-based position receiver 230 at around the time a map is being requested by mobile device 200 (even if indoors); however, the location determined using the satellite-based positioning system may not be precise or accurate enough to determine which floor of a building or region of the floor of a building mobile device 200 is located on. As such, the position determined using satellite-based position receiver 230 may be used for a position estimate.

In some embodiments, location estimation engine 212 may use only a position determined using data from cellular network transceiver 220 or satellite-based position receiver 230. In other embodiments, the location estimate may be based on whichever source provided the most recent position data. In still other embodiments, the position estimate may be based on a combination (e.g., an average) of the position of the mobile device determined using data from cellular network transceiver 220 and satellite-based position receiver 230. In some embodiments, if positioning information determined using cellular network transceiver 220 and satellite-based position receiver 230 is sufficiently out of date, a user of mobile device 200 may be requested to provide a position estimate, such as by entering an address of the building where the mobile device is located via user input module 260.

In some embodiments, local wireless network transceiver 240 may serve to receive signals from multiple access points in the vicinity of mobile device 200. In some embodiments, the local wireless network transceiver 240 is configured to communicate using the 802.11 (a/b/g/n) protocol; other protocols may also be possible. Local wireless network transceiver 240 may be used for bidirectional communication with an access point or may only receive transmitted data from an access point (such as due to either mobile device 200 not having permission to communicate using the access point or the access point being a transmit-only beacon). The information collected by mobile device 200 via a local wireless network transceiver 240 may be used to determine where indoors mobile device 200 is located. Local wireless network transceiver 240 may be, at minimum, configured to receive identifiers from access points and conduct signal strength measurements, such as RSSI measurements of signals received from access points.

Disambiguation evaluation engine 214 may be configured to receive an indication of a disambiguation evaluation technique from a remote server system. Such disambiguation evaluation techniques may refer to different algorithms which can be applied to signal strength measurements (additionally or alternatively, round trip times (RTT) may be measured and used) taken via local wireless network transceiver 240 to determine the location of mobile device 200. Disambiguation evaluation engine 214 may also be configured to receive multiple location hypotheses from the remote server system. The multiple location hypotheses and the disambiguation evaluation technique to be used by disambiguation evaluation engine 214 may be received by mobile device 200 via either cellular network transceiver 220 or (if mobile device 200 has access permission to the local network) via local wireless network transceiver 240. Disambiguation evaluation engine 214 may also be configured to receive various tuning parameters from the remote server system via cellular network transceiver 220 and/or local wireless network transceiver 240.

Mobile device 200 may be configured to display a map via a display 250. The map displayed may be intended to represent a floor in a building on which mobile device 200 is located, a region of the floor in a building in which mobile device 200 is located, or some other type of map. Display 250 may also be configured to indicate a location on the map where mobile device 200 is determined to be located. For instance, a dot on the map displayed by display 250 may indicate the location of mobile device 200.

User input module 260 of mobile device 200 may be used for a user of mobile device 200 to provide feedback as to the map presented via display 250. The user may indicate whether or not the map presented via display 250 is correct for the location of mobile device 200. Receiving such feedback may be useful in determining whether the location hypotheses and the disambiguation evaluation technique received from the remote server system were correct. Whether positive or negative feedback is received from a user via user input module 260, mobile device 200 may transmit the feedback to the remote server system via either cellular network transceiver 220 or local wireless network transceiver 240 (if mobile device 200 has permission to access the Internet via one or more access points in communication with local wireless network transceiver 240).

FIG. 3 illustrates an embodiment of an indoor map 300 presented by a mobile device. Indoor map 300 may be presented, for example, by display 250 of mobile device 200 of FIG. 2. Additionally or alternatively, the mobile device presenting indoor map 300 may represent mobile device 110, which is part of system 100 of FIG. 1. Indoor map 300 presents a floor plan 310 of a single floor of a building where the mobile device (and the user possessing the mobile device) is located. The location of the mobile device is indicated on the floor plan 310 at location indicator 320. As such, a user viewing indoor map 300 via the mobile device can view floor plan 310 of the floor of the building where the mobile device is located and a location indicator 320 which indicates where the mobile device is located. Additionally, feedback interface 330 may be present. Feedback interface 330 may allow a user to provide input to the mobile device indicating whether floor plan 310 represents the correct floor or correct portion of the floor where the mobile device is located. The user may provide positive feedback (i.e., the map displayed is correct) or negative feedback (i.e., the map displayed is incorrect). Feedback may be transmitted to the remote server system from which floor plan 310 was received.

If a user indicates via feedback interface 330 that the map is incorrect, the user may be invited to specify the building, floor, and/or portion of floor where the mobile device is located. For example, the user may be presented with a list of choices of possible locations of the mobile device in the form of a menu. In some embodiments, if negative feedback is provided by the user, the mobile device may make a second attempt to determine a correct location context identifier and request a different floor plan from a remote server system. For example, if multiple location hypotheses were evaluated by the mobile device, the second attempt may involve requesting a map associated with an LCI of the second most likely hypothesis. In some embodiments, the same location hypotheses may be reevaluated using a different disambiguation evaluation technique with the LCI of the most likely hypothesis being requested from the remote server system if the most likely hypothesis does not match the hypothesis determined to be incorrect.

Various methods may be performed using the systems and mobile devices described. FIG. 4 illustrates an embodiment of a method 400 for performing LCI disambiguation. Method 400 may be performed using system 100 of FIG. 1 or some other system that may be used for performing LCI disambiguation. Method 400 involves the use of a mobile device. The mobile device may be mobile device 200 of FIG. 2 or some other embodiment of a mobile device. Each step of method 400 may be performed using a mobile device. The mobile device is computerized. As such, the mobile device used to perform method 400 may have some or all of the components of computer system 700 of FIG. 7. Means for performing steps of method 400 generally include computerized devices, such as mobile devices, cellular phones, laptop computers, tablet computers, gaming devices, personal digital assistants, and the like. More specifically, means for performing steps of method 400 include processors, non-transitory computer-readable storage mediums, and wireless communication interfaces.

At step 410, the mobile device may receive multiple location hypotheses. These multiple location hypotheses may be received from a remote server system. For example, referring to system 100 of FIG. 1, the multiple location hypotheses may be received by mobile device 110 from remote server system 150 via either base station 140 of a cellular wireless network or via an access point of access points 180 (if mobile device 110 has permission to access Internet 130 via access points 180). Each location hypothesis of the multiple location hypotheses may be associated with a different LCI. Each LCI may be in the form of an identifier unique from each other LCI. Each LCI may be associated with a specific map stored or accessible by the remote server system. The multiple location hypotheses may have been selected by the remote server system based on a position estimate provided by the mobile device to the remote server system. The position estimate may have been based on measurements using a satellite navigation position system and/or cellular network base station triangulation or trilateration.

The multiple location hypotheses obtained from the remote server may each indicate one or more MAC addresses (or some other form of identifier, such as a name) for one or more access points located on the floor of the building or a region of the floor of the building corresponding to the location hypothesis. As an example, referring to system 100 of FIG. 1, a location hypothesis for the second floor of building 160 may indicate information including: an LCI for the second floor of building 160, and four MAC addresses for the four access points 180. Another location hypothesis for mobile device 110 which may be received may be: an LCI for the first floor of building 160, and MAC addresses for access points located on the first floor of the building. Table 1 provides an exemplary location hypothesis for the second floor of building 160.

TABLE 1

| LCI | MAC Addresses of APs |
|---|---|
| 0x349a92d | 00-14-32-F1-23-C5 |
| | 00-23-33-D3-F3-0F |
| | 00-34-A2-AC-23-FF |

The number of location hypotheses received by the mobile device may be dependent on the accuracy of a location estimate provided to the remote server system by the mobile device. The more accurate the location estimate, the fewer number of location hypotheses may need to be provided to the mobile device for evaluation. Further, the number of location hypotheses provided to the mobile device may depend on the number of maps available for the general area where the mobile device is located. For example, if a mobile device is likely within a two story building, there may only be two relevant maps, with each associated with the location hypothesis. However, if the mobile device is likely located within a ten story building, a much greater number of maps, such as eight or ten, may each be associated with a location hypothesis, with each location hypothesis being provided to the mobile device.

At step 420, an indication of a location disambiguation technique to be performed may be received by the mobile device. The indication of the location disambiguation technique may be received from the remote server system from which the multiple location hypotheses were received. The indication of the location disambiguation technique may be either an algorithm for the mobile device to evaluate for each location hypothesis or an indication of an algorithm (which may already be stored by the mobile device) for the mobile device to evaluate for each location hypothesis.

As examples of various disambiguation algorithms, two examples are provided herein. A first exemplary disambiguation algorithm involves minimizing a summation in which a measured RSSI value for each AP within a location hypothesis has a nominal RSSI value subtracted, as presented in equation 1:

LCI_{hyp}=Σⱼ[RSSIⱼ−RSSIₙₒₘ(j,LCI_{hyp})]² Eq. 1

The nominal value (RSSIₙₒₘ(j, LCI_{hyp}) for each AP of the LCI hypothesis may be received as a tuning parameter from the remote server system or a standard value stored by the mobile device may be used. This value may be the nominal RSSI from the jth AP in LCI_{hyp}. If the jth AP is part of LCI_{hyp} (which may mean the jth AP is on the floor associated with LCI_{hyp}), it may be assigned an intra-floor RSSI nominal value. If the jth AP is not part of LCI_{hyp} (which may mean the jth AP is on another floor not associated with the LCI_{hyp}), it may be assigned an inter-floor RSSI nominal value). Within a location hypothesis, a number of APs may be indicated, such as by MAC address. The mobile device may take RSSI measurements for each AP from which it can receive a wireless signal. If an AP for which an RSSI measurement was made is indicated in a location hypothesis, the measured RSSI value (RSSIⱼ) has the nominal value subtracted and is used in evaluating equation 1. In some embodiments, if a measurement cannot be made for an AP indicated in a location hypothesis, a predefined nominal value (representing a very low signal strength) may be used for the RSSIⱼ value. Equation 1 may be evaluated for each received location hypothesis. The LCI of the location hypothesis which produces the minimum value of equation 1 may be considered as the correct LCI for the location of the mobile device.

A second exemplary disambiguation algorithm involves maximizing a summation in which the measured RSSI value for each AP within an LCI hypothesis has a nominal value subtracted, as presented in equation 2:

LCI_{hyp}=arg max Σ_{APεLCI}_{_{hyp}}(RSSI_{AP}−R) Eq. 2

The nominal value R for each AP of the LCI hypothesis may be received as a tuning parameter from the remote server system or may be stored by the mobile device. R may be the average of the inter-floor and intra-floor expected RSSI values, such as −70 dB. Equation 2 may be used to select the location hypothesis that produces the maximum value. The LCI of the location hypothesis with the largest value from equation 2 may then be considered as the correct LCI for the location of the mobile device. In some embodiments, if the number of APs in different location hypotheses for which RSSI measurements are successfully made vary, a nominal value RSSI (e.g., −96 dB) may be used to pad the observations such that a same number of “measurements” are used in evaluating each location hypothesis. Such inclusion of APs for which an actual measurement was not made may allow negative information (the absence of a measurement) to be taken into account. Such negative information may imply that the AP is significantly far enough from the mobile device that an RSSI measurement cannot be made.

In some embodiments, regardless of whether the first, second, or some other equation is used, RSSI measurements made by the mobile device may have a minimum cap and/or a maximum cap. RSSI measurements that are made for an AP and are below the minimum cap may be increased to the minimum cap; RSSI measurements that are made for an AP and are greater than the maximum cap may be decreased to the maximum cap. Such capping may allow for more robust determination of the correct LCI, such as by eliminating certain measurements from having too much (or too little) weight. For instance, a line-of-sight communication path between the mobile device and an AP located on another floor of a building (e.g., via a building's multi-floor atrium or stairwell) may exist.

Regardless of which disambiguation algorithm is used, evaluation of the algorithm may occur at the mobile device. Such processing of the disambiguation techniques at the mobile device may reduce the amount of data needed to be sent between the remote server system and the mobile device and reduce the processing load of the remote server system. For instance, if only two disambiguation techniques are used, a single bit may be used by the remote server system to indicate which disambiguation technique the mobile device is to use. It should be understood that variations on and other disambiguation algorithms may be possible in addition to these two examples. Further, it should be understood that rather than two possible disambiguation algorithms, 3, 4, 5, 6, 7, or more than 7 disambiguation algorithms may be available for use as the disambiguation technique performed by the mobile device. Further, at various points in time, additional disambiguation techniques may be introduced by providing the algorithm to the mobile device. As such, the location disambiguation technique used by a mobile device a first time at a location may not be the same location disambiguation technique that the remote server system requests the mobile device to perform at a second, later time.

At step 430, the mobile device may measure the signal strength of each AP with which the mobile device can receive a signal. The measurement may be an RSSI measurement (in some embodiments, RTT measurements may additionally or alternatively be conducted). As such, the number of RSSI measurements performed by the mobile device may be dependent on the number of APs sufficiently close to the mobile device for at least a signal of a minimum signal strength to be detected by the mobile device. Referring to mobile device 200 of FIG. 2, local wireless network transceiver 240 may be used to receive and measure the signal strength of each AP within communication range of the mobile device. The measurements conducted at step 430 may be stored in association with identifiers of the APs from which the signal was received. As such, each RSSI measurement may be associated with an identifier of an AP, such as a MAC address. The RSSI measurements and the associated AP identifiers may be stored by the mobile device. RSSI measurements may be performed multiple times by the mobile device, with results averaged for each AP. Further, it should be understood that the measurements may be taken before an indication of the disambiguation technique or the multiple location hypotheses are received. RSSI measurements and the corresponding MAC addresses for access points that are not present in any of the location hypotheses may be ignored (e.g., not used in performing any location disambiguation techniques) and/or not stored. As an example, such MAC addresses may correspond to access points on which the remote server system has no information.

At step 440, the location disambiguation technique specified by the remote server system may be evaluated for each of the received multiple location hypotheses at the mobile device. As such, each location hypothesis of the multiple location hypotheses is evaluated at the mobile device using the specified location disambiguation technique. A value may result for each location hypothesis. The processing of step 440 may be performed at the mobile device.

Depending on the location disambiguation algorithm used, the location hypothesis associated with the greatest or smallest value may be selected as the correct location hypothesis. As such, step 450 may include comparing the values determined for each location hypothesis using the disambiguation technique at step 440 and selecting the greatest or smallest value. Once a particular location hypothesis has been selected as correct, the associated LCI (or other form of identifier) may be transmitted to the remote server in order to retrieve a correct map that is associated with the LCI for the mobile device's location.

At step 470, the map corresponding to the LCI transmitted to the remote server system at step 460 may be received. This map may be presented by the mobile device at step 480. The map may be presented to a user of the mobile device. On the map, an indication of the location of the mobile device may be provided. In alternate embodiments, the map may be presented by the mobile device at step 480 but no indication of the specific location of the mobile device is presented on the map.

In some embodiments, multiple disambiguation techniques may be performed by the mobile device. The hypothesis selected as correct may be based on “voting” among the multiple disambiguation techniques (e.g., the hypothesis identified by the majority of disambiguation techniques is selected as correct. As such, the remote server may identify multiple disambiguation techniques to be performed by the mobile device. In some embodiments, when one of the multiple disambiguation techniques is performed, a confidence level is also determined for the disambiguation technique. The confidence level may be based on the difference between a value associated with the hypothesis selected by the disambiguation technique as correct and next highest value associated with the second hypothesis—the larger the difference, the greater the confidence value. If the confidence level is below a threshold value, a different disambiguation algorithm may be used or voting may be used.

FIG. 5 illustrates an embodiment of a method 500 for performing LCI disambiguation. While method 400 focused on steps performed by a mobile device, method 500 provides an embodiment of a method having steps performed by the mobile device and the remote server system. It should be understood that either column presented in FIG. 5 could be interpreted as a separate method performed exclusively by a system or device. Method 500 may be performed using system 100 of FIG. 1 or some other system that may be used for performing LCI disambiguation. Method 500 involves the use of a mobile device and a remote server system. The mobile device may be mobile device 200 of FIG. 2 or some other embodiment of a mobile device. Each step of method 500 may be performed using a mobile device and/or a remote server system, as indicated in FIG. 5. The mobile device and the remote server system are computerized. As such, the mobile device and the remote server system used to perform method 500 may have some or all of the components of computer system 700 of FIG. 7. Means for performing steps of method 500 generally include computerized devices, such as mobile devices, computer systems, cellular phones, laptop computers, tablet computers, gaming devices, personal digital assistants, and the like. More specifically, means for performing steps of method 500 include processors, non-transitory computer-readable storage mediums, and wireless communication interfaces. Further, performance of steps of method 500 may involve additional components, such as presented in FIG. 1. For instance, for communication between a mobile device and a remote server system, one or more wireless networks may be used.

At step 505, the mobile device may determine a location estimate. The location estimate may be based on the most recently determined location of the mobile device or may be based on a location determination technique that is insufficient to determine the floor of a building or section of a floor of a building on which the mobile device is located. For example, the location estimate of step 505 may be based on a satellite-based location determination arrangement (e.g., GPS). The satellite-based location determination may have been conducted at some time in the past (e.g., just before the mobile device entered the building and was able to receive timing signals from a sufficient number of satellites). The satellite-based location determination may be conducted presently, but may not be of sufficient accuracy and precision to determine a floor within a building or section of the floor within the building on which the mobile device is located. Similarly, the location estimate of step 505 may be based on trilateration or triangulation performed using multiple base stations of one or more cellular wireless networks. The triangulation or trilateration location estimate technique may have been conducted sometime in the past (e.g., just before the mobile device entered the building and was able to receive timing signals from a sufficient number of base stations). The triangulation or trilateration location estimate technique may also be conducted presently, but may not be of sufficient accuracy and precision to determine a floor within a building or section of the floor within the building on which the mobile device is located. It should be understood that in other embodiments, some other form of location determination may be used to determine the location estimate of step 505.

In some embodiments, the location estimate may be based on a single (or some other number) of APs from which the mobile device can receive signals. For instance, a MAC address (or other form of identifier) of a single AP from which the mobile device has received a signal may be transmitted to the remote server system. As such, the remote server system may be able to determine that the mobile device is at least within communication range of the AP associated with the received MAC address or other identifier.

At step 510, the location estimate determined at step 505 may be transmitted to the remote server system along with information sufficient to identify the mobile device. At step 515, the location estimate may be received by the remote server system along with information sufficient to identify the mobile device. Communication between the mobile device and the remote server may occur via one or more wireless networks. Referring to FIG. 1, mobile device 110 may communicate with remote server system 150 via a cellular wireless network (which may include base station 140). Additionally or alternatively, mobile device 110 may communicate with remote server system 150 via one or more access points 180 if mobile device 110 has permission to access Internet 130 via access points 180.

At step 520, using the location estimate received at step 515, the remote server system may determine multiple location hypotheses. Each location hypothesis of the multiple location hypotheses may correspond to a location consistent with the location estimate. For example, if the location estimate indicates a particular building, each location hypothesis may correspond to a floor within the building or each location hypothesis may correspond to a section of a floor within the building. The staleness of the occasion estimate may be factored in by the remote server system in determining the multiple location hypotheses. For example, if the location estimate is based on a location determination performed by the mobile device more than a threshold period of time ago, the remote server system may make location hypotheses based on an assumption that in the time since the location estimate was determined the mobile device may have traveled a farther distance. The number of location hypotheses identified by the remote server system may be dependent on the accuracy of a location estimate provided to the remote server system by the mobile device. The more accurate the location estimate, the fewer number of location hypotheses may need to be provided to the mobile device for evaluation. Further, the number of location hypotheses provided to the mobile device by the remote server system may depend on the number of maps available for the general area where the mobile device is located: the greater number of maps of locations near the position estimate, the greater number of location hypotheses that need to be evaluated by the mobile device to determine the correct location hypothesis. The remote server system may be required to determine at least a minimum and/or no more than a maximum number of location hypotheses at step 520.

At step 525, the multiple location hypotheses based on the location estimate received at step 515 may be transmitted by the remote server system to the mobile device. At step 530 these multiple location hypotheses may be received by mobile device.

At step 535, the remote server system may select a location disambiguation technique from multiple disambiguation techniques for the mobile device to use in evaluating the multiple location hypotheses. The remote server system may store data that indicates places (e.g., buildings, cities, addresses, etc.) where a particular disambiguation technique has been found to be more accurate than other disambiguation techniques. In some embodiments, the remote server system may indicate a default disambiguation technique to the mobile device, unless the remote server system has data indicating that the default disambiguation technique has been found to be inaccurate in places near the location estimate received from the mobile device. In some embodiments, the remote server system has access to a limited number of location disambiguation techniques, such as two. In other embodiments, three or more location disambiguation techniques may be available to the remote server system for selection.

Additionally, at step 535, one or more tuning parameters may be selected by the remote server system. The tuning parameters may be values that are input into the selected location disambiguation technique when the associated algorithm is evaluated. For example, a tuning parameter may be a nominal value used in calculating the location disambiguation technique, such as (RSSIₙₒₘ) of equation 1. The values of tuning parameters may vary by location disambiguation technique and/or by the location estimate received from the mobile device. In some instances, the values of tuning parameters may vary by the make and/or model of the mobile device. The mobile device may store default values for tuning parameters. These default values may be overridden if alternate tuning parameter values are received from the remote server system.

At step 540, in indication of the selected disambiguation technique may be transmitted to the mobile device. The indication of the selected disambiguation technique may be an identifier associated with the disambiguation technique. Based on the identifier, the mobile device may be able to select a locally-stored disambiguation algorithm. In some embodiments, the algorithm of the location disambiguation technique is transmitted to the mobile device. Additionally, at step 540, one or more tuning parameters may be transmitted to the mobile device. Such tuning parameters may only be transmitted to the mobile device if the values of the tuning parameters are different than the faults tuning parameter values stored by the mobile device. At step 545, the indication of the selected disambiguation technique may be received by the mobile device. Further, at step 545, any transmitted values of tuning parameters may be received by the mobile device.

At step 550, the mobile device may measure the signal strength of each AP with which the mobile device can receive a signal. Each measurement may be an RSSI measurement. As such, the number of RSSI measurements performed by the mobile device may be dependent on the number of APs within communication range of the mobile device for at least a signal of a minimum signal strength to be received by the mobile device. The measurements performed at step 550 may be stored in association with identifiers of the APs from which the signal was received. As such, each RSSI measurement may be associated with an identifier of an AP, such as a MAC address. The RSSI measurements may be made in dB. The RSSI measurements (which may be in dB) and the associated AP identifiers may be stored by the mobile device. RSSI measurements may be performed multiple times by the mobile device, with results averaged for each AP (or otherwise combined, for example, the maximum RSSI measurement may be used for each AP). Further, it should be understood that the measurements may be taken before an indication of the disambiguation technique or the multiple location hypotheses is received.

At step 555, the location disambiguation technique specified by the remote server system may be evaluated for each of the received multiple location hypotheses at the mobile device. As two examples, equation 1 or equation 2 may be used as the location disambiguation technique. As such, each location hypothesis of the multiple location hypotheses is evaluated at the mobile device using the specified location disambiguation technique and any received tuning parameters. If tuning parameters are required and no tuning parameters received from the remote server system, the mobile device may use stored default values for the tuning parameters. A value may result for each location hypothesis. Processing of step 555 may be performed at the mobile device. RSSI measurements and the corresponding MAC addresses for APs that are not present in any of the location hypotheses may be ignored (e.g., not used in performing any location disambiguation techniques) and/or not stored. As an example, such MAC addresses may correspond to access points on which the remote server system has no information.

Depending on the location disambiguation algorithm used, the location hypothesis associated with the greatest or smallest value may be selected as the correct location hypothesis. As such, step 560 may include comparing the values determined for each location hypothesis using the disambiguation technique at step 555 and selecting the greatest or smallest value.

Once a particular location hypothesis has been selected as correct, the associated LCI (or other form of identifier) may be transmitted to the remote server system in order to retrieve a correct map that is associated with the LCI for the mobile device's location. Accordingly, at step 565, the LCI or other form of indication of the location hypothesis identified as correct may be transmitted to the remote server system. At step 570, the syndication of the location hypothesis identified as correct may be received by the remote server system.

At step 575, based on the received LCI (or other form of identifier), the map associated with the received LCI may be determined. This may involve consulting a database such as map database 155-3 of system 100 of FIG. 1. The map determined at step 575 may be transmitted to the mobile device by the remote server system at step 580. At step 585, the map may be received by the mobile device.

The received map may be presented by the mobile device at step 590. The map may be presented to a user of the mobile device. On the map, an indication of the location of the mobile device may be provided. In some embodiments, while the map presented at step 590 is determined using method 500, the location of the mobile device within the map may be determined by some other position determination technique, such as a satellite-based position determining technique (e.g., GPS) or a cellular network base station trilateration or triangulation technique. In some embodiments, the map may be presented by the mobile device at step 580 but no indication of the specific location of the mobile device is presented on the map.

While method 400 and method 500 may often determine the correct LCI for a location of the mobile device, and thus a correct map, there may be situations where the wrong LCI is determined. In such situations, a different location disambiguation technique may have yielded the correct LCI. Alternatively, the second most likely LCI may have, in fact, been correct. In order to identify such situations where the wrong LCI was determined and to eliminate or decrease the chances of such an incorrect determination occurring in the future (for either the same mobile device or some other mobile device) feedback to the remote server system may be used. This feedback may be used to determine whether a different location disambiguation technique should be used for particular locations (e.g., buildings), types of mobile devices, times of day, etc.

FIG. 6 illustrates an embodiment of a method 600 for using user feedback in performing LCI disambiguation. It should be understood that either column presented in FIG. 5 could be interpreted as a separate method performed exclusively by a remote server system or mobile device. Method 600 may be performed using system 100 of FIG. 1 or some other system that may be used for performing LCI disambiguation. Method 600 involves the use of a mobile device and a remote server system. The mobile device may be mobile device 200 of FIG. 2 or some other embodiment of a mobile device. Each step of method 600 may be performed using a mobile device and/or a remote server system, as indicated in FIG. 6. The mobile device and the remote server system are computerized. As such, the mobile device and the remote server system used to perform method 600 may have some or all of the components of computer system 700 of FIG. 7. Means for performing steps of method 600 generally include computerized devices, such as mobile devices, computer systems, cellular phones, laptop computers, tablet computers, gaming devices, personal digital assistants, and the like. More specifically, means for performing steps of method 600 include processors, non-transitory computer-readable storage mediums, and wireless communication interfaces. Further, performance of steps of method 600 may involve additional components, such as presented in FIG. 1. For instance, for communication between a mobile device and a remote server system, one or more wireless networks may be used.

Further, it should be understood that method 600 may be performed as part of either method 400 or method 500. For example, method 600 may be performed after step 590 of method 500. The steps of method 600 may result in a different disambiguation technique and/or different tuning parameters being determined by the remote server system for future performance of method 500 for a similar location of the mobile device. Further, such feedback may be used to modify the disambiguation technique and/or the one or more tuning parameters for other mobile devices. As such, feedback provided by particular user may benefit other users of other mobile devices which are also in communication with the remote server system to perform LCI disambiguation and receive maps.

At step 610, user input may be received that indicates whether a map being presented by a mobile device is correct or incorrect. For instance, a map may be incorrect if the map corresponds to a floor on which the mobile device is not located. As an example of a way in which a user may provide feedback as to whether the map displayed is correct or not, a feedback interface, such as feedback interface 330 of FIG. 3, may be presented by the mobile device to the user. Feedback interface 330 may permit a user to provide feedback indicating whether the map is correct or the map is incorrect.

At step 620, the indication of whether the map is correct or not may be transmitted by the mobile device to the remote server system. An indication of a session which the mobile device held with the remote server system in order to retrieve the incorrect map may be indicated with the data transmitted at step 620. Alternatively, the remote server system may be able to determine the session in which the incorrect map was provided to the mobile device based on stored data related to the most recent map provided to the specific mobile device. In some embodiments, the mobile device may provide the remote server system with sufficient information to determine the conditions under which the incorrect map was identified: such sufficient information may include the position estimate, an indication of the location disambiguation technique used, the location hypotheses provided by the remote server system to the mobile device, and/or any tuning parameters provided by the remote server system to the mobile device. At step 630, the indication of whether the map was correct or incorrect may be received by the remote server system along with any other data related to the feedback transmitted by the mobile device.

At step 640, the feedback database may be updated using the information received from the mobile device at step 630. For instance, the feedback database used at step 640 may represent feedback database 155-4 of system 100 of FIG. 1. Feedback used to update the feedback database at step 640 may be associated with particular LCIs (and maps) and/or with location estimates received from mobile device. Feedback that indicates that the map was correct may serve to reinforce the use of particular location hypotheses, location disambiguation techniques, and/or the tuning parameters provided by the remote server system to the mobile device. Thus, the positive feedback may result in the same location hypotheses, location disambiguation techniques and/or tuning parameters being provided to mobile devices in the future that provide similar position estimates. Feedback that indicates the map was incorrect may serve to decrease the likelihood that particular location hypotheses, a location disambiguation technique, and/or the tuning parameters will be provided to mobile devices in the future that provide similar position estimates. In some embodiments, if enough negative feedback is received for a particular LCI or location estimate, the location disambiguation technique indicated by the remote server system to mobile devices for similar position estimates in the future may be changed based on the feedback. It may be required that negative feedback be received from a minimum number of mobile devices for a particular position estimate or LCI before the location disambiguation technique selected by the remote server system is changed. For example, a minimum of five instances of negative feedback may be required.

In some embodiments, if negative feedback has been received by the remote server system from the mobile device, the remote server system may provide the mobile device with alternate tuning parameters, an alternate disambiguation technique and/or alternate location hypotheses to evaluate in an attempt to determine a correct map based on where the mobile device is located. In such embodiments, following step 650, method 600 may proceed to step 545 of method 500 of FIG. 5. In some embodiments, the user may be provided with a menu to select a correct map. Based on the correct map selected by the user, the feedback database may be updated. In some embodiments, rather than performing another disambiguation technique, the second most likely location hypothesis (and its associated LCI) may be used to retrieve a second map for presentation to the user by the mobile device (and possible feedback).

FIG. 7 illustrates an embodiment of a computer system. A computer system as illustrated in FIG. 7 may be incorporated as part of the previously described computerized devices. For example, computer system 700 can represent some of the components of the mobile devices and/or the remote server systems discussed in this application. FIG. 7 provides a schematic illustration of one embodiment of a computer system 700 that can perform the methods provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a mouse, a keyboard, and/or the like; and one or more output devices 720, which can include without limitation a display device, a printer, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the non-transitory storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 (and/or components thereof) generally will receive signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

It should further be understood that the components of computer system 700 can be distributed across a network. For example, some processing may be performed in one location using a first processor while other processing may be performed by another processor remote from the first processor. Other components of computer system 700 may be similarly distributed.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bind the scope of the claims.

What is claimed is:

1. A method for performing location disambiguation, the method comprising:
receiving, by a mobile device, a plurality of location hypotheses;
receiving, by the mobile device, an indication of a disambiguation evaluation technique selected from a plurality of disambiguation evaluation techniques, wherein
the disambiguation evaluation technique is to be used for performing location disambiguation;
performing, by the mobile device, the disambiguation evaluation technique using the plurality of location hypotheses; and
selecting, by the mobile device, a location hypothesis of the plurality of location hypotheses as corresponding to a location of the mobile device based on the performed disambiguation evaluation technique.

2. The method for performing the location disambiguation of claim 1, further comprising:
prior to receiving, by the mobile device, the plurality of location hypotheses:
determining, by the mobile device, a location estimate of the mobile device; and
transmitting, by the mobile device, the location estimate to a remote server system, wherein the plurality of location hypotheses are selected by the remote server system based on the location estimate.

3. The method for performing the location disambiguation of claim 2, further comprising:
receiving, by the remote server system, the location estimate from the mobile device;
selecting, by the remote server system, the disambiguation evaluation technique selected from the plurality of disambiguation evaluation techniques based on the location estimate received from the mobile device; and
transmitting, by the remote server system, the indication of the disambiguation evaluation technique selected from the plurality of disambiguation evaluation techniques to the mobile device.

4. The method for performing the location disambiguation of claim 2, further comprising:
receiving, by the remote server system, the location estimate from the mobile device;
determining, by the remote server system, the plurality of location hypotheses based on the location estimate; and
transmitting, by the remote server system, the plurality of location hypotheses based on the location estimate to the mobile device.

5. The method for performing the location disambiguation of claim 1, further comprising:
transmitting, by the mobile device, an indication of the location hypothesis selected as corresponding to the location of the mobile device to a remote server system; and
in response to transmitting the indication of the location hypothesis selected as corresponding to the location of the mobile device, receiving, by the mobile device, a map linked with the location hypothesis selected by the mobile device as corresponding to the location of the mobile device.

6. The method for performing the location disambiguation of claim 5, further comprising:
receiving, by the mobile device, user input indicating the map does not correspond to the location of the mobile device; and
transmitting, by the mobile device, an error notification, wherein:
the error notification indicates the map has been identified as incorrect by user input, and
the error notification is used by the remote server system to modify one or more future selections of the disambiguation evaluation technique from the plurality of disambiguation evaluation techniques.

7. The method for performing the location disambiguation of claim 1, the method further comprising:
receiving, by the mobile device, a tuning parameter for the disambiguation evaluation technique for use in performing the disambiguation evaluation technique wherein
performing the disambiguation evaluation technique further comprises using the tuning parameter.

8. The method for performing the location disambiguation of claim 1, wherein each location hypothesis of the plurality of location hypotheses corresponds to a different floor of a building.

9. The method for performing the location disambiguation of claim 1, wherein each location hypothesis of the plurality of location hypotheses corresponds to a different region of a building.

10. A mobile device for performing location disambiguation, the mobile device comprising:
one or more processors; and
a memory communicatively coupled with and readable by the one or more processors and having stored therein processor-readable instructions which, when executed by the one or more processors, cause the one or more processors to:
receive a plurality of location hypotheses;
receive an indication of a disambiguation evaluation technique selected from a plurality of disambiguation evaluation techniques, wherein
the disambiguation evaluation technique is to be used for performing location disambiguation;
perform the disambiguation evaluation technique using the plurality of location hypotheses; and
select a location hypothesis of the plurality of location hypotheses as corresponding to a location of the mobile device based on the performed disambiguation evaluation technique.

11. The mobile device for performing the location disambiguation of claim 10, wherein the processor-readable instructions are further configured to cause the one or more processors to:
prior to receiving the plurality of location hypotheses:
determine a location estimate of the mobile device; and
cause the location estimate to be transmitted to a remote server system, wherein the plurality of location hypotheses are selected by the remote server system based on the location estimate.

12. The mobile device for performing the location disambiguation of claim 10, wherein the processor-readable instructions are further configured to cause the one or more processors to:
cause an indication of the location hypothesis selected as corresponding to the location of the mobile device to be transmitted to a remote server system; and
receive a map linked with the location hypothesis selected by the mobile device as corresponding to the location of the mobile device.

13. The mobile device for performing the location disambiguation of claim 12, wherein the processor-readable instructions are further configured to cause the one or more processors to:
receive user input indicating the map does not correspond to the location of the mobile device; and
cause an error notification to be transmitted to the remote server system, wherein
the error notification indicates the map has been identified as incorrect by user input, and
the error notification is used by the remote server system to modify one or more future selections of the disambiguation evaluation technique from the plurality of disambiguation evaluation techniques.

14. The mobile device for performing the location disambiguation of claim 10, wherein the processor-readable instructions are further configured to cause the one or more processors to:
receive a tuning parameter for the disambiguation evaluation technique for use in performing the disambiguation evaluation technique wherein
the processor-readable instructions that cause the one or more processors to perform the disambiguation evaluation technique further comprises additional processor-readable instructions that cause the one or more processors to perform the disambiguation evaluation technique using the tuning parameter.

15. The mobile device for performing the location disambiguation of claim 10, wherein each location hypothesis of the plurality of location hypotheses corresponds to a different floor of a building.

16. The mobile device for performing the location disambiguation of claim 10, wherein each location hypothesis of the plurality of location hypotheses corresponds to a different region of a building.

17. A non-transitory processor-readable medium for performing location disambiguation, comprising processor-readable instructions configured to cause one or more processors to:
receive a plurality of location hypotheses;
receive an indication of a disambiguation evaluation technique selected from a plurality of disambiguation evaluation techniques, wherein
the disambiguation evaluation technique is to be used for performing location disambiguation;
perform the disambiguation evaluation technique using the plurality of location hypotheses; and
select a location hypothesis of the plurality of location hypotheses as corresponding to a location of a mobile device based on the performed disambiguation evaluation technique.

18. The non-transitory processor-readable medium for performing the location disambiguation of claim 17, wherein the processor-readable instructions are further configured to cause the one or more processors to:
prior to receiving the plurality of location hypotheses:
determine a location estimate of the mobile device; and
cause the location estimate to be transmitted to a remote server system, wherein the plurality of location hypotheses are selected by the remote server system based on the location estimate.

19. The non-transitory processor-readable medium for performing the location disambiguation of claim 17, wherein the processor-readable instructions are further configured to cause the one or more processors to:
cause an indication of the location hypothesis selected as corresponding to the location of the mobile device to be transmitted to a remote server system; and
receive a map linked with the location hypothesis selected by the mobile device as corresponding to the location of the mobile device.

20. The non-transitory processor-readable medium for performing the location disambiguation of claim 19, wherein the processor-readable instructions are further configured to cause the one or more processors to:
receive user input indicating the map does not correspond to the location of the mobile device; and
cause an error notification to be transmitted to the remote server system, wherein
the error notification indicates the map has been identified as incorrect by user input, and
the error notification is used by the remote server system to modify one or more future selections of the disambiguation evaluation technique from the plurality of disambiguation evaluation techniques.

21. The non-transitory processor-readable medium for performing the location disambiguation of claim 17, wherein the processor-readable instructions are further configured to cause the one or more processors to:
receive a tuning parameter for the disambiguation evaluation technique for use in performing the disambiguation evaluation technique wherein
the processor-readable instructions that cause the one or more processors to perform the disambiguation evaluation technique further comprises additional processor-readable instructions that cause the one or more processors to perform the disambiguation evaluation technique using the tuning parameter.

22. The non-transitory processor-readable medium for performing the location disambiguation of claim 17, wherein each location hypothesis of the plurality of location hypotheses corresponds to a different floor of a building.

23. The non-transitory processor-readable medium for performing the location disambiguation of claim 17, wherein each location hypothesis of the plurality of location hypotheses corresponds to a different region of a building.

24. An apparatus for performing location disambiguation, the apparatus comprising:
means for receiving a plurality of location hypotheses;
means for receiving an indication of a disambiguation evaluation technique selected from a plurality of disambiguation evaluation techniques, wherein
the disambiguation evaluation technique is to be used for performing location disambiguation;
means for performing the disambiguation evaluation technique using the plurality of location hypotheses; and
means for selecting a location hypothesis of the plurality of location hypotheses as corresponding to a location of a mobile device based on the performed disambiguation evaluation technique.

25. The apparatus for performing the location disambiguation of claim 24, further comprising:
means for determining a location estimate of the mobile device; and
means for transmitting the location estimate to a remote server system, wherein the plurality of location hypotheses are selected by the remote server system based on the location estimate.

26. The apparatus for performing the location disambiguation of claim 25, further comprising:
means for receiving the location estimate from the mobile device;
means for selecting the disambiguation evaluation technique selected from the plurality of disambiguation evaluation techniques based on the location estimate received from the mobile device; and
means for transmitting the indication of the disambiguation evaluation technique selected from the plurality of disambiguation evaluation techniques to the mobile device.

27. The apparatus for performing the location disambiguation of claim 25, further comprising:
means for receiving the location estimate from the mobile device;
means for determining the plurality of location hypotheses based on the location estimate; and
means for transmitting the plurality of location hypotheses based on the location estimate to the mobile device.

28. The apparatus for performing the location disambiguation of claim 24, further comprising:
means for transmitting an indication of the location hypothesis selected as corresponding to the location of the mobile device to a remote server system; and
means for receiving a map linked with the location hypothesis selected by the mobile device as corresponding to the location of the mobile device.

29. The apparatus for performing the location disambiguation of claim 28, further comprising:
means for receiving user input indicating the map does not correspond to the location of the mobile device; and
means for transmitting an error notification, wherein:
the error notification indicates the map has been identified as incorrect by user input, and
the error notification is used by the remote server system to modify one or more future selections of the disambiguation evaluation technique from the plurality of disambiguation evaluation techniques.

30. The apparatus for performing the location disambiguation of claim 24, the apparatus further comprising:
means for receiving a tuning parameter for the disambiguation evaluation technique for use in performing the disambiguation evaluation technique wherein
the means for performing the disambiguation evaluation technique further comprises using the tuning parameter.

31. The apparatus for performing the location disambiguation of claim 24, wherein each location hypothesis of the plurality of location hypotheses corresponds to a different floor of a building.

32. The apparatus for performing the location disambiguation of claim 24, wherein each location hypothesis of the plurality of location hypotheses corresponds to a different region of a building.
